(19) United States
(12) Patent Application Publication
(10) Pub. No.: US 2020/0406568 A1
(43) Pub. Date: Dec. 31, 2020

(54) METHODS AND SYSTEMS FOR PACKAGING ERECTION

(71) Applicant: Packsize LLC, Salt Lake City, UT (US)

(72) Inventor: Horst Reinkensmeyer, Herford (DE)

(21) Appl. No.: 16/452,268

(22) Filed: Jun. 25, 2019

(51) Int. Cl. B31B 50/26; B31B 50/20; B31B 50/62

(52) U.S. Cl. CPC B31B 50/262; B31B 2100/00; B31B 50/624; B31B 50/20

(57) ABSTRACT

Methods of erecting boxes include providing box templates having a plurality of panels. Some of the panels have an adhesive disposed thereon. The box template is folded to form a partially folded box template. Some of the panels are attached together with the adhesive on some of the panels to hold the box template in the partially folded state even without user assistance. The box template is further folded to form a completely erected. Some of the panels are attached together with the adhesive on some of the panels to hold the box template in the completely erected state even without user assistance. Additionally, securing elements may be used to more securely maintain the box template in the completely erected state.

### BACKGROUND

### 1. The Technical Field

Example embodiments of the present disclosure relate to methods and systems for erecting and assembling packaging. More particularly, example embodiments of the disclosure relate to methods and systems that assists a user in erecting and closing boxes made from corrugated board.

### 2. The Relevant Technology

For decades now, the shipping and other industries have commonly made use of corrugated board boxes. In general, the manufacture of a corrugated board box is performed by using an automated machine known as a converter to produce a box template. This type of a machine may perform a number of different functions on raw corrugated board to produce a corrugated board box template. Example machines, may, for example, take raw corrugated board from a roll or fanfold stack, and crease, cut, fold, perforate, score, or otherwise manipulate the raw corrugated board to produce a desired shape and design.

The shape, size, and design of the template may vary based on any of a number of different considerations. For instance, the dimensions of an item or product to be contained in the box may form the basis of particular dimensions of the box. Depending on other factors—such as the desired design, ease of assembly, protective characteristics of the box—an infinite number of possible template configurations are available.

Notwithstanding the infinite variety available for boxes and other packaging, many box templates have been standardized. Some examples of standardized box sizes and styles include the FEFCO 416 (also known as the One Piece Folder, or OPF), the FEFCO 412, the FEFCO 429, the FEFCO 410, FEFCO 201, and the Regular Slotted Container, or RSC. These are only some examples, and it is appreciated that any number of other box styles and standardized box sizes and configurations may exist now or in the future. Moreover, a single automated converter may produce any number of different box styles.

Once a box template is formed, a human generally must manually erect the box by folding the box template according to the pattern formed in the template. During the erecting process, sections of the box template are folded in a generally sequential order. It is often necessary to hold one section of folded box template in place while folding another section of box template in order to create the box. Holding a section of folded box template in place while folding another section often times creates difficulty in the erecting process. For example, by holding one section in place, the assembler may have only one hand available to fold, crease, or insert other sections. This may make it difficult, if not impossible, for a single person to erect certain styles and sizes of boxes alone. Thus, at least some styles of boxes require such a high level of involvement that usually two or more people must collectively erect the box.

When more than one person is needed to erect a box, valuable human resources are spent on erecting the box. Moreover, even if a single person is able to erect a box alone, the process of erecting a box may be difficult and slow, thus again wasting valuable time and resources. Furthermore, due to the nature of erecting a box (e.g., having to hold certain portions of the folded template in place while folding other portions of the template), a difficult to assemble box may be erected with poor quality, thereby causing the box to be scrapped, thus wasting time and materials. Alternatively, a poorly erected box that is used to ship items may not have the requisite box integrity to protect the items placed in the box, thus increasing the risk of damage to the items located within the poorly erected box.

In an effort to address some of the foregoing challenges with erecting boxes, various specialized tables and jigs have been developed. Some of these specialized tables and jigs are designed to hold portions of a partially erected box in place while a person makes additional folds to fully erect the box. Unfortunately, many of these specialized tables and jigs have limited capabilities and/or are cumbersome to use. For instance, many of these specialized tables and jigs are designed to be used when erecting a single style and/or size of box. As a result, these specialized tables and jigs are not versatile enough to assist with erecting boxes of different styles and/or sizes. Such a shortcoming can be particularly problematic for a fulfillment center that boxes items of numerous sizes and shapes.

The subject matter disclosed and claimed herein is not limited to embodiments that solve any disadvantage or difficulties, or that operate only in environments such as those described above. Rather, this background is only intended to illustrate one exemplary technology area where some embodiments described herein may be practiced. Accordingly, foregoing description is merely exemplary.

### BRIEF SUMMARY

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

Exemplary embodiments of the disclosure relate to systems and methods for forming erecting packaging templates into boxes. For instance, one embodiment of a method of erecting a box includes providing a box template having a plurality of panels. One or more of the panels has an adhesive disposed thereon. The method also includes making one or more initial folds in the box template to form a partially folded box template. After making the one or more initial folds, at least two panels of the plurality of panels are attached together with the adhesive on at least one of the panels. The adhesive is configured to stabilize the folded panels of the partially folded box template such that the partially folded box template remains in its partially folded state even without user assistance. The method also includes performing one or more additional folds in the box template to completely erect the box from the box template.

According to another embodiment, a method of erecting a box includes providing a box template having a plurality of panels with one or more of the panels having an adhesive disposed thereon. The method also includes folding a first subset of the panels of the box template to form a partially folded box template. One or more panels of the first subset has an adhesive disposed thereon. The method further includes attaching the first subset of the panels together to hold the box template in the partially folded configuration even without user assistance. The adhesive disposed on the one or more panels of the first subset is used to attach the first subset of panels together. Additionally, the method includes folding a second subset of the panels of the box template to form a closed box. One or more panels of the second subset has an adhesive disposed thereon. The second subset of the panels are attached together to hold the box template in the closed box configuration even without user assistance. The adhesive disposed on the one or more panels of the second subset is used to attach the second subset of panels together.

According to another embodiment, a method of erecting a box and packaging an item therein includes providing a box template having a plurality of panels and one or more of the panels having an adhesive disposed thereon. A first subset of the panels of the box template are folded to form a partially folded box template. One or more panels of the first subset has adhesive disposed thereon. At least one panel of the first subset of panels is attached to the item to hold the box template in the partially folded configuration even without user assistance. The adhesive disposed on the at least one panel of the first subset is used to attach the at least one panel of the first subset to the item. A second subset of the panels of the box template is folded to form a closed box. One or more panels of the second subset has adhesive disposed thereon. The second subset of the panels is attached together or to the item to hold the box template in the closed box configuration even without user assistance. The adhesive disposed on the one or more panels of the second subset is used to attach the second subset of panels together or to the item.

Additional features and advantages of the invention will be set forth in the description which follows, and in part will be obvious from the description, or may be learned by the practice of the invention. The features and advantages of the invention may be realized and obtained by means of the instruments and combinations particularly pointed out in the appended claims. These and other features of the present invention will become more fully apparent from the following description and appended claims, or may be learned by the practice of the invention as set forth hereinafter.

### BRIEF DESCRIPTION OF THE DRAWINGS

To further clarify the above and other advantages and features of the present invention, a more particular description of the invention will be rendered by reference to specific embodiments thereof which are illustrated in the appended drawings. It is appreciated that these drawings depict only illustrated embodiments of the invention and are therefore not to be considered limiting of its scope. The invention will be described and explained with additional specificity and detail through the use of the accompanying drawings in which:

FIG. 1 illustrates an example system for forming packaging templates.

FIG. 2 illustrate an example box template for use in the present invention.

FIG. 3 illustrates an example adhesive applied to the box template of FIG. 2.

FIGS. 4-9B illustrates an example process for erecting and closing the packaging template of FIG. 2.

### DETAILED DESCRIPTION

The embodiments described herein extend to methods, devices, systems, assemblies, and apparatus for erecting packaging materials. More particularly, the following description will particularly describe methods, devices, systems, assemblies, and apparatus for assembling and erecting boxes made from corrugated board. It will be appreciated, however, that the example embodiments disclosed herein are not limited to production and/or erection of boxes or use with corrugated board, and such a description is provided merely to illustrate an example environment in which the disclosed invention may be used.

Reference will now be made to the drawings to describe various aspects of exemplary embodiments. It is understood that the drawings are diagrammatic and schematic representations of such exemplary embodiments and are not intended to limit the present invention, except to the extent expressly claimed. Similarly, no particular elements should be considered essential for all embodiments, nor should any elements be interpreted as requiring assembly or manufacture in any particular order or manner. Accordingly, no inference should be drawn from the drawings as to the necessity or ordering of any element. In the following description, numerous specific details are set forth in order to provide a thorough understanding of the present invention. It will be obvious, however, to someone of ordinary skill in the art that the present invention may be practiced without these specific details. In other cases, general manufacturing techniques and packaging products are not herein described in detail in order to avoid unnecessarily obscuring the novel aspects of the present invention.

As used herein, the term “converting machine” is utilized herein to generically describe a variety of different machines that may take raw materials and convert the raw materials into a different form or structure. For example, a “converting machine” as used herein includes packaging machines that receive packaging materials (e.g., corrugated board) and cut, perforate, crease, score, fold, or otherwise modify the packaging materials to produce a box template. The term “converting machine” may, however, refer to other types of machines and industries, and is not necessarily limited to machines used to make box templates, nor to machines usable in the packaging industry.

Further, in describing and claiming the present invention, the terms “packaging materials” and “sheet materials” are utilized herein to generically describe a variety of different types of materials that may be converted using a converting machine. For example, “packaging materials” or “sheet materials” may be used to effectively refer to any material that can be converted from a raw form into a usable product, or into a template for a usable product. For instance, paper-based materials such as cardboard, corrugated board, paper board, and the like may be considered “packaging materials” or “sheet materials” although the term is not necessarily so limited. Accordingly, while examples herein describe the use of corrugated board and fanfold corrugated board, such are merely exemplary and not necessarily limiting of the present application.

Additionally, the term “box” may be used to generically describe different types of packages and packaging components that can be used to package, transport, and/or ship items. A “box” as used herein is not intended to be limited to generally rectangular prism shaped packages as boxes may be commonly thought of. Rather, as used herein, a “box” is intended to encompass packages of various shapes, sizes, or configuration.

The terms “packaging template,” “box template,” and “template” are used interchangeably and refer to a substantially flat stock of material that can be folded into a package. A template may have notches, cutouts, divides, and/or creases that allow the template to be bent and/or folded into a package. Additionally, a template may be made of any suitable packaging material.

As used herein, the term “crease” shall refer to a line along which the template may be folded. For example, a crease may be an indentation in the template material, which may aid in folding portions of the template separated by the crease, with respect to one another. A suitable indentation may be created by applying sufficient pressure to reduce the thickness of the material in the desired location and/or by removing some of the material along the desired location, such as by scoring.

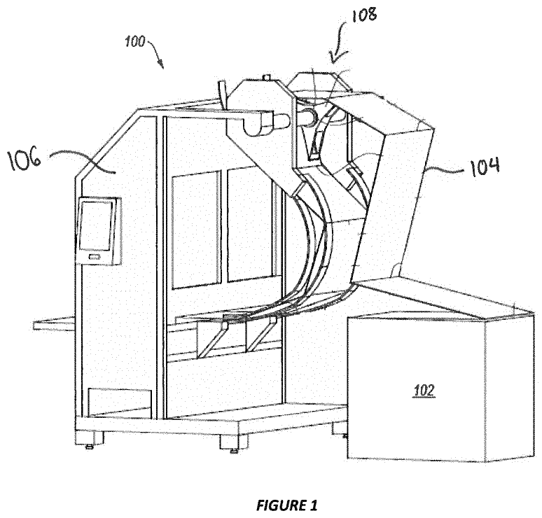

FIG. 1 illustrates an example system 100 that may be used to create packaging templates. The system 100 includes a bale 102 of sheet material 104, a converting machine 106, and an infeed system 108. The infeed system 108 is configured to guide the sheet material 104 into the converting machine 106. The converting machine 106 can perform one or more conversion functions (e.g., crease, bend, fold, perforate, cut, score) on the sheet material 104 to form a packaging template from the sheet material 104. The converting machine 106 may include one or more converting tools for performing the conversion functions on the sheet material 104. Additionally, in some embodiments, the converting machine 106 may optionally apply adhesive (via one or more adhesive applicators) to one or more portions of the packaging template as part of the process for forming the packaging template, as described in greater detail below. In other embodiments, the adhesive may be applied to the packaging template manually or with another machine after the packaging template forming process is complete.

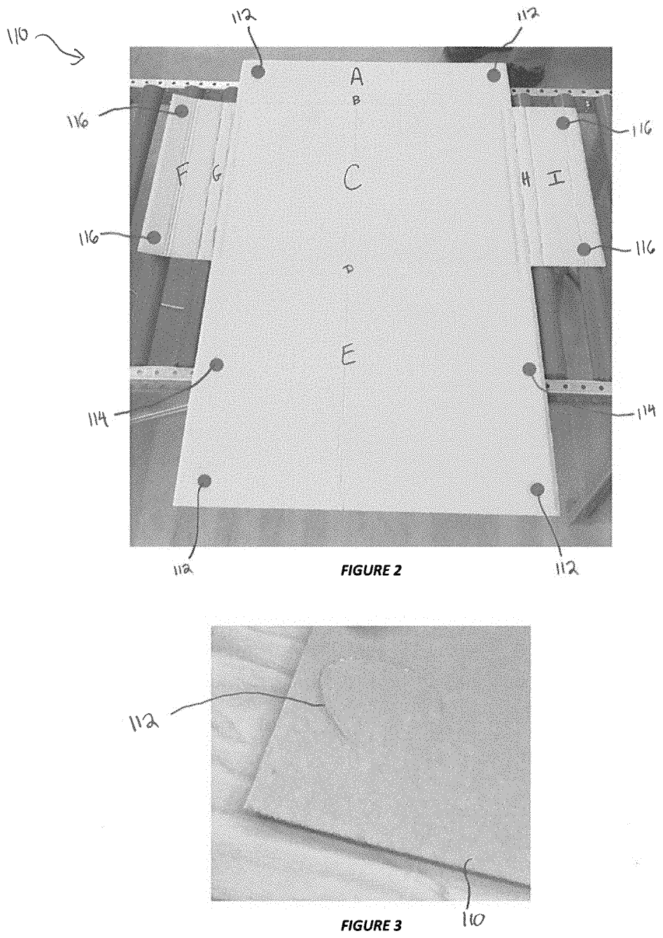

Attention is now directed to FIG. 2, which illustrates an example packaging template 110 that may be formed with the converting machine 106. The packaging template 110 is illustrated and will be described below with a particular configuration and associated process for erecting and closing a box formed therewith. However, it will be appreciated that the packaging template 110 may take other forms and the process for erecting and closing a box formed from a packaging template may vary from one embodiment to another. Nevertheless, the general principles described below in connection with the packaging template 110, including the application of adhesive thereto and the manner of erecting and closing a box formed therewith, are generally applicable to any packaging template and manner of erecting and close a box formed therewith. Thus, the principles described herein may be employed with packaging templates of various sizes and styles.

In the illustrated embodiment, the packaging template 110 includes a plurality of panels A, B, C, D, E, F, G, H, I defined by creases formed between adjacent panels and/or edges of the packaging template 110. The creases in the packaging template 110 can be formed with one or more conversion tools of the converting machine 106. Similarly, the edges of the packaging template 110 can be formed by cutting (e.g., with one or more conversion tools of the converting machine 106) excess material from the sheet material 104 to define the outer shape of the packaging template 110.

As will be described below, the packaging template 110 can be folded along some or all of the creased formed therein in order to erect the packaging template 110 into a box. When the packaging template 110 is erected into a box, some or all of the panels A-I can form all or a portion of a wall of the resulting box formed with the packaging template 110.

In addition to forming creases and cuts in the sheet material 104 to form the packaging template 110, FIG. 2 illustrates adhesive applied to the packaging template 110. As will be described in greater detail below, the adhesive can be used to assist with erecting the packaging template 110 into a box.

In the illustrated embodiment, adhesive has been applied to a plurality of discreet locations or portions of the packaging template 110. For instance, each of panels A and E has adhesive 112 applied adjacent to distant corners thereof. As used herein, a “distant corner” of a panel may refer to a corner of a panel that is positioned away from an adjacent panel. For instance, panel E has distant corners (e.g., where adhesive 112 is applied) that are positioned away from adjacent panel D. In contrast, an “adjacent corner” of a panel may refer to a corner of a panel that is positioned close or adjacent to an adjacent panel (e.g., the corners of panel E closest to panel D). Panel E also includes adhesive 114 applied near opposing edges thereof. In the illustrated embodiment, the adhesive 114 is applied about half way between the distant and adjacent corners of the panel E.

As described in greater detail below, the adhesives 112, 114 may be used to at least temporarily hold portions of the packaging template 110 in desired configurations or orientations during an erecting and/or closing process. For instance, the adhesives 112, 114 may be used to at least temporarily attach various portions of the packaging template 110 together to hold the packaging template 110 in the desired configurations or orientations.

In some embodiments, as can also be seen in FIG. 2, adhesive 116 can optionally be applied to portions of the packaging template 110. For instance, panels F and I have adhesive 116 applied to distant corners thereof. Similar to the adhesives 112, 114, the adhesive 116 can also be used to at least temporarily hold portions of the packaging template 110 in desired configurations or orientations during an erecting and/or closing process. For instance, the adhesive 116 may optionally be used to at least temporarily attach various portions of the packaging template 110 to one or more items being packaged within the box formed with the packaging template 110. By attaching portions of the packaging template 110 to the one or more items being packaged therein, the adhesive 116 can hold portions of the packaging template 110 in a desired configuration or orientation while other portions of the packaging template 110 are folded and/or closed.

While the packaging template 110 has been shown and described as having adhesives 112, 114, and 116 applied on particular portions thereof, such is merely exemplary. In other embodiments, for instance, adhesive may be applied to one or more portions of one or more panels. By way of example, panel A may have adhesive applied to a single portion thereof or more than two portions thereof. Additionally, the specific portions of the packaging template 110 that have adhesive applied thereto may vary from one embodiment to another. For instance, rather having adhesive applies to discreet locations on the packaging template 110, the adhesive could be applied more broadly. By way of example, panel E may have a line of adhesive applied between the distant and adjacent corners thereof. In still other embodiments, some of the panels may not have adhesive applied thereto. By way of example, panels F and I may not have adhesive 116 applied thereto.

Turning attention to FIG. 3, there is shown one example of the adhesive 112 applied to the packaging template 110. In the illustrated embodiment, the adhesive 112 is a glue that is applied to the packaging template 110. In the illustrated embodiment, the glue is applied in a generally circular shape. In other embodiments, the glue can be applied in lines, squares, or other regular or irregular shapes.

In some embodiments, the glue may be an elastic glue. In some embodiments, the glue may have a relatively long open time such that the glue does not cure before the packaging template 110 is erected. In some embodiments, the glue may be pressure sensitive or pressure activated. In such cases, the glue may not bond or adhere to another item until a pressure above a predetermined threshold has been applied to the glue.

In some embodiments, the glue may be configured to rapidly or almost instantaneously connect the panels of the packaging template 110 together or to a to-be-packaged item. The rapid or almost instantaneous connection provided by the glue can allow the glue to hold the packaging template in a desired folded configuration (e.g., partially folded configuration, completely folded or closed configuration) during an erecting process, as discussed below. Glue that provides the rapid or almost instantaneously connection can be particularly useful when erecting boxes because it allows the boxes to be erected quickly and allows a person or machine that is erecting the boxes to quickly proceed with subsequent erecting steps rather than having to wait for a glue with a longer curing time or one that does not provide for the rapid or almost instantaneous connection.

Examples of suitable glues include Technomelt PS 8746 from Henkel, POLCO Melt PSA H 3389/2 from Follmann, and Glue 61628.1 from Bühnen. It will be appreciated that the noted glues are merely exemplary and that other glues that have similar characteristics to those described herein may also be used.

In other embodiments, the adhesives 112, 114, 116 may take the form of double-sided tape. In some embodiments, the double-sided tape may exhibit at least some of the same properties described above in connection with suitable glues. For example, the double-sided tape may have a relatively long open time, may be pressure activated, etc.

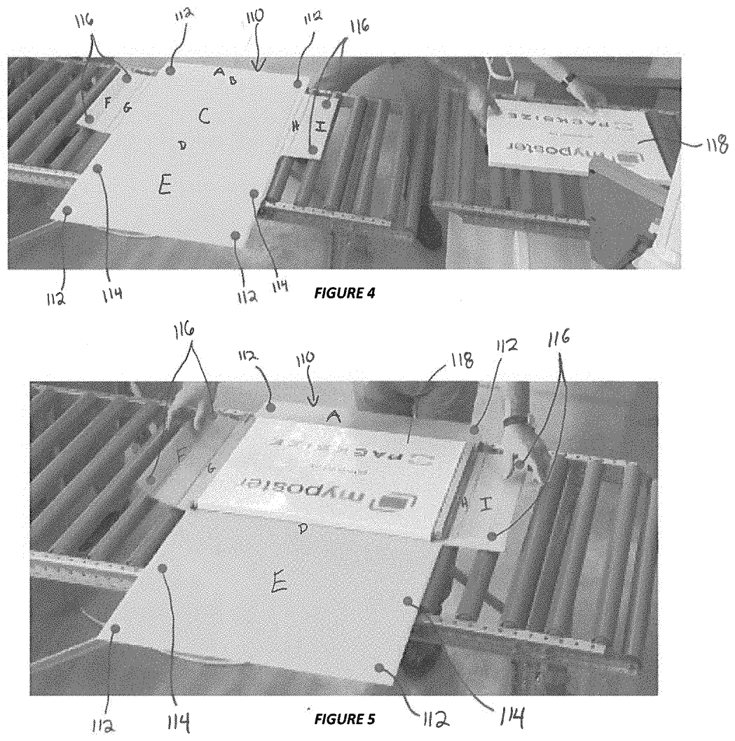

Turning now to FIGS. 4-9B, an example process for erecting and closing packaging template 110 will now be described. As alluded to above, the following process is merely exemplary. The packaging template 110 may be erected and closed using other processes. Similarly, the process for erecting and closing packaging templates having different configurations from the packaging template 110 may vary from the following description. Nevertheless, the general principles may be applicable to various embodiments of packaging templates and erection/closing processes.

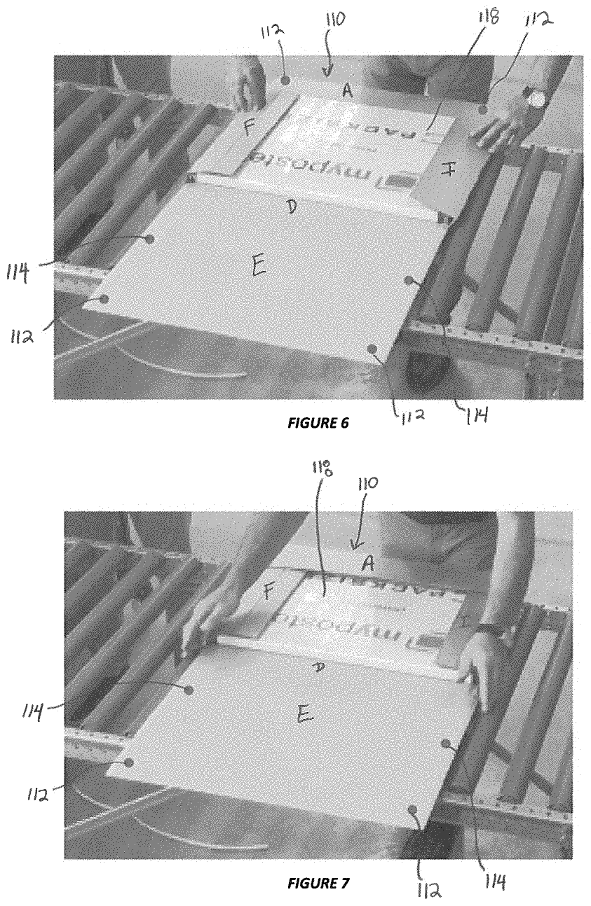

As shown in FIG. 4, the packaging template 110 is provided and includes the adhesives 112, 114, 116 applied thereto as described above. An item 118 for packaging within a box formed from the packaging template 110 is also provided. In the illustrated embodiment, a box is erected from the packaging template 110 by folding the packaging template 110 around the item 118. For instance, the item 118 may be placed on panel C of the packaging template 110 as shown in FIG. 5. Thereafter, the remainder of the packaging template 110 can be folding around the item as shown in FIGS. 6-8.

Before proceeding with a more detailed description of the process for folding or erecting a box around the item 118, it will be appreciated that the process is merely exemplary. In other embodiments, for instance, the packaging template 110 may be folded into a partially erected box. Thereafter, the item 118 may be placed inside the partially erected box. In some embodiments, placing the item 118 inside of the partially erected box can assist with holding or maintaining the box template in the partially erected state. Additional folding and/or other erecting steps may then be performed to create a fully erected box with the item 118 therein.

Returning to the illustrated embodiment, as shown in FIG. 6, panels F, G, H, I can be folded around the item 118. When so folded, panels G and H may form sidewalls of the box being erected. Similarly, panels F and I may also form portions of a wall of the box being erected.

In embodiments that include the optional adhesive 116 on panels F and I, the adhesive 116 may be used to at least temporarily attach panels F and Ito the item 118. Such attachment of panels F and Ito the item 118 may hold panels F and I (as well as panels G and H) in the folded positions shown in FIG. 6. In such embodiments, the person or machine that is erecting the box does not have to hold panels F and I (or panels G and H) in place while proceeding with the next folding steps. Rather, the attachment of the panels F and Ito the item 118 can free up the hands of the person or components of the machine to be used in the subsequent folding steps.

As shown in FIG. 7, panels A and B can be folded around the item 118 similar to panels F, G, H, and I. In particular, panel B can be folded towards the item 118 so that panel B forms a sidewall of the box that is being erected. Similarly, panel A can be folded relative to panel B so that panel A forms part of the same wall of the box that is at least partially formed by panels F and I.

When panel A is folded as shown in FIG. 7, the adhesive 112 thereon can be used to at least temporarily attach panel A to one or more of panels F and I and/or the item 118, depending on the specific placement(s) of the adhesive. Such attachment of panel A to at least one of panel F and I and/or the item 118 may hold panel A (as well as panel B) in the folded position shown in FIG. 7. In such embodiments, the person or machine that is erecting the box does not have to hold panel A (or panel B) in place while proceeding with the next folding steps. Rather, the attachment of panel A to at least one of panels F and I and/or the item 118 can free up the hands of the person or components of the machine to be used in the subsequent folding steps.

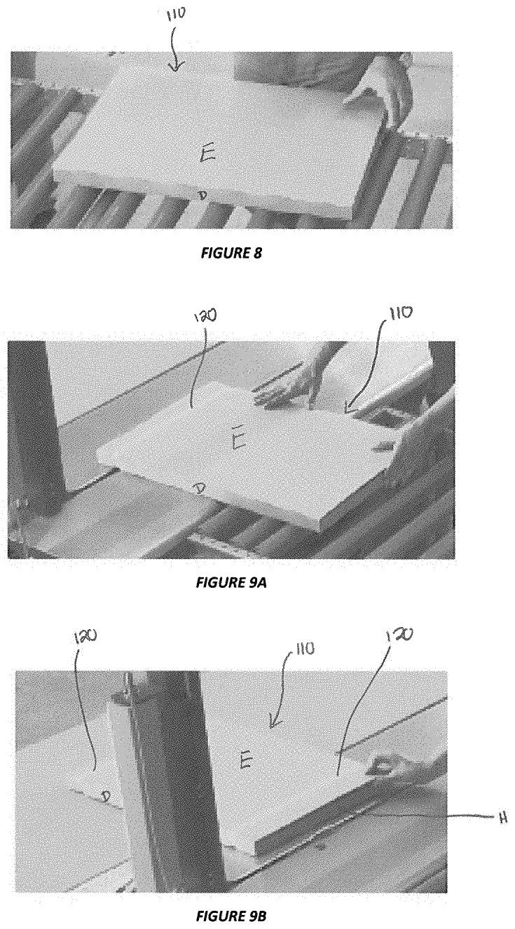

As shown in FIG. 8, panels D and E can be folded around the item 118 similar to panels A and B. In particular, panel D can be folded towards the item 118 so that panel D forms a sidewall of the box that is being erected. Similarly, panel E can be folded relative to panel D so that panel E forms a wall of the box that is opposite to panel C.

When panel E is folded as shown in FIG. 8, the adhesive 112 thereon can be used to at least temporarily attach panel E to one or more of panels A, F, and I and/or the item 118. Such attachment of panel E to at least one of panels A, F, and I and/or the item 118 may hold panel E (as well as panel D) in the folded position shown in FIG. 8. In such embodiments, the person or machine that is erecting the box does not have to hold panel E (or panel D) in place while proceeding with subsequent closure steps. Rather, the attachment of the panel E to at least one of panels A, F, and I and/or the item 118 can free up the hands of the person or components of the machine to be used in the subsequent closure steps.

As shown in FIGS. 9A and 9B, once the box template 110 has been erected or assembled into a box, including at least temporarily attaching one or more of the panels to each other or the item being packaged therein, the resulting box can be more securely closed. As used herein, closing or more securely closing a box refers to connecting portions of the packaging template 110 together in a manner that will limit or prevent the box from being unintentionally opened or removed from around the item 118. In some cases, the adhesive(s) 112, 114, 116 on the packaging template 110 may not provide sufficient strength or attach the panels of the packaging template 110 in a manner that will securely close the resulting box. Accordingly, one or more additionally securing elements may be applied to the resulting box in order to securely close the box.

For instance, as shown in FIGS. 9A and 9B, one or more straps 120 may be secured around the box. The strap(s) may limit or prevent the panels of the packaging template 110 from unintentionally or undesirably unfolding from around the item 118. Straps 120 are one example of additional securing elements that can be used to securely close a box formed with the packaging template 110. In other embodiments, the one or more additional securing elements may include adhesive tape, staples, rivets, and/or additional glue applied to the packaging template 110 to secure the panels thereof together.

After the items 118 has been packaged with the packaging template 110 as described above, the package can be stored, shipped, or otherwise processed. When it is desired to open the package and retrieve the item 118, the one or more additional securing elements may be disengaged, disabled, or removed from the box. For instance, tap applied across multiple panels may be cut or removed. Similarly, straps 120 may be cut or otherwise removed.

Once the one or more additional securing elements are disengaged, disabled, or removed from the box, one or more of the panels of the box can be unfolded. For instance, panels D and E may be unfolded to provide access to the items 118. In order to unfold panels D and E, the adhesive(s) 112, 114 (that at least temporarily secured panel E to one or more of panels A, F, and I and/or the item 118) may need to be disengaged, disabled, or removed. This may be accomplished by applying a sufficient pulling force to panel E to overcome the strength of the adhesive(s) 112, 114 and/or the material from which the packaging template 110 is formed.

In some embodiments, unfolding panels D and E may provide sufficient access to the item 118 and allow the item to be removed from the partially open box. In other embodiments, the box may need to be further deconstructed to enable removal of the item 118. The process for deconstructing the box may be the reverse process used to erect or assemble the box. In some embodiments, the deconstruction may only require disconnecting panels of the box from one another and unfolding the panels.

In other optional embodiments, the deconstruction may also or alternatively require disconnecting one or more panels from the item 118. For instance, if adhesive 116 was used to attach panels F and Ito the item 118, part of the deconstruction process may include disconnecting panels F and I from the item 118. In some embodiments, the adhesive(s) used to connect the panel(s) to the item 118 may allow for the noted connection as well as removal of the adhesive(s) from the item 118 (e.g., when deconstructing the box or removing the item 118 therefrom) without damaging the item. By way of example, the adhesive(s) may provide sufficient holding power to facilitate erecting of the box as described above. However, the adhesive(s) may be configured to be peeled off of the item 118 upon the application of a sufficient force and/or application of a force in a particular manner (e.g., peeling from on edge of the adhesive).

In light of the above, it will be appreciated that the general principles of the present disclosure include applying an adhesive to a packaging template, folding one or more of panels of the packaging template to at least partially erect a box therefrom, and securing one or more of the panels to one or more other panels and/or the item being packaged with the adhesive to hold the panels in a desired configuration or orientation while additional folds and/or other erecting process steps are performed. In addition to using an adhesive to facilitate the box erecting process (e.g., to hold the panels is desired positions while additional folds are made), the principles of the present disclosure also include using one or more additional securing element to securely close the box and limit or prevent unintentional or undesirable opening thereof.

The present invention may be embodied in other specific forms without departing from its spirit or essential characteristics. The described embodiments are to be considered in all the tough to respects only as illustrative and not restrictive. The scope of the invention is, therefore, indicated by the appended claims rather than by the foregoing description. All changes which come within the meaning and range of equivalency of the claims are to be embraced within their scope.

What is claimed is:

1. A method of erecting a box, comprising:
providing a box template, the box template having a plurality of panels, one or more panels of the plurality of panels having an adhesive disposed thereon;
making one or more initial folds in the box template to form a partially folded box template;
after making the one or more initial folds, attaching at least two panels of the plurality of panels together with the adhesive on at least one panel of the one or more panels having an adhesive disposed thereon, wherein the adhesive is configured to stabilize the folded panels of the partially folded box template such that the partially folded box template remains in its partially folded state even without user assistance; and
performing one or more additional folds in the box template to completely erect the box from the box template.

2. The method of erecting a box as recited in claim 1, wherein providing a box template comprises forming one or more cuts and one or more creases in a sheet material and applying the adhesive to the one or more panels.

3. The method of erecting a box as recited in claim 2, wherein applying the adhesive to the one or more panels comprises applying a glue or double-sided tape to the one or more panels.

4. The method of erecting a box as recited in claim 3, wherein the glue comprises at least one of an elastic glue, a long time open glue, a pressure sensitive glue, or a pressure activated glue.

5. The method of erecting a box as recited in claim 2, wherein applying the adhesive to the one or more panels is performed as part of a process for forming the packaging template.

6. The method of erecting a box as recited in claim 1, wherein making the one or more initial folds comprises folding one or more of the panels to bring planar surfaces of the one or more panels into contact with one another.

7. The method of erecting a box as recited in claim 6, wherein folding the one or more the panels to bring planar surfaces of the one or more panels into contact with one another comprises folding the one or more the panels so that the adhesive is disposed between the planar surfaces of the one or more panels.

8. The method of erecting a box as recited in claim 1, further comprising positioning a to-be-packaged item within the erected box on the box template prior to making the one or more initial folds.

9. The method of erecting a box as recited in claim 8, wherein making the one or more initial folds comprises folding at least one of the panels to bring the at least one panel into contact with the to-be-packaged item.

10. The method of erecting a box as recited in claim 9, further comprising attaching the at least one panel to the to-be-packaged item with adhesive disposed on the at least one panel.

11. The method of erecting a box as recited in claim 1, further comprising positioning an item to be packaged within the erected box in the partially folded box after making the one or more initial folds.

12. The method of erecting a box as recited in claim 1, further comprising, after performing the one or more additional folds, attaching at least two panels of the plurality of panels together with the adhesive on at least one panel of the one or more panels having an adhesive disposed thereon, wherein the adhesive is configured to stabilize the folded panels of the completely erected box such that the completely erected box remains in its erected state even without user assistance.

13. The method of erecting a box as recited in claim 12, further comprising applying one or more additional securing elements to the erected box to maintain the folded panels of the erected box such that the completely erected box remains in its erected state.

14. The method of erecting a box as recited in claim 13, wherein applying one or more additional securing elements comprises applying one or more straps, tape, staples, glue, or combinations thereof to the erected box.

15. A method of erecting a box, comprising:
providing a box template, the box template having a plurality of panels, one or more panels of the plurality of panels having an adhesive disposed thereon;
folding a first subset of the panels of the box template to form a partially folded box template, one or more panels of the first subset having adhesive disposed thereon;
attaching the first subset of the panels together to hold the box template in the partially folded configuration even without user assistance, wherein the adhesive disposed on the one or more panels of the first subset is used to attach the first subset of panels together;
folding a second subset of the panels of the box template to form a closed box, one or more panels of the second subset having adhesive disposed thereon; and
attaching the second subset of the panels together to hold the box template in the closed box configuration even without user assistance, wherein the adhesive disposed on the one or more panels of the second subset is used to attach the second subset of panels together.

16. The method of erecting a box as recited in claim 15, further comprising packaging an item in the box.

17. The method of erecting a box as recited in claim 16, wherein packaging the item in the box comprises positioning the item on a panel of the packaging template prior to folding the first subset of the panels.

18. The method of erecting a box as recited in claim 17, further comprising attaching at least one panel of the first subset of the panels to the item to hold the box template in the partially folded configuration even without user assistance, wherein the adhesive disposed on the at least one panel of the first subset is used to attach the at least one panel of the first subset to the item.

19. The method of erecting a box as recited in claim 16, wherein packaging an item in the box comprises positioning the item in the box template when the box template is in the partially folded configuration.

20. The method of erecting a box as recited in claim 19, further comprising attaching at least one panel of the second subset of the panels to the item to hold the box template in the closed box configuration even without user assistance, wherein the adhesive disposed on the at least one panel of the second subset is used to attach the at least one panel of the second subset to the item.

21. A method of erecting a box and packaging an item therein, comprising:
providing a box template, the box template having a plurality of panels, one or more panels of the plurality of panels having an adhesive disposed thereon;
folding a first subset of the panels of the box template to form a partially folded box template, one or more panels of the first subset having adhesive disposed thereon;
attaching at least one panel of the first subset of panels to the item to hold the box template in the partially folded configuration even without user assistance, wherein the adhesive disposed on the at least one panel of the first subset is used to attach the at least one panel of the first subset to the item;
folding a second subset of the panels of the box template to form a closed box, one or more panels of the second subset having adhesive disposed thereon; and
attaching the second subset of the panels together or to the item to hold the box template in the closed box configuration even without user assistance, wherein the adhesive disposed on the one or more panels of the second subset is used to attach the second subset of panels together or to the item.
